(19) United States
(12) Patent Application Publication
(10) Pub. No.: US 2016/0302899 A1
(43) Pub. Date: Oct. 20, 2016

(54) Flossing Instrument

(71) Applicants: Carlo Honanian, Glendale, CA (US); Jack Krikorian, West Hills, CA (US)

(72) Inventors: Carlo Honanian, Glendale, CA (US); Jack Krikorian, West Hills, CA (US)

(21) Appl. No.: 14/688,284

(22) Filed: Apr. 16, 2015

(51) Int. Cl. A61C 15/04

(52) U.S. Cl. CPC A61C 15/046

(57) ABSTRACT

A multi-filament flossing instrument which supports more than one flossing filament thereon. The instrument comprises a first arm, a second arm a third arm, and optionally, a fourth arm. The arms may radiate from a common point or from another arm. Each flossing filament spans two of the arms. One arm may be devoid of attachment to filaments, to function as a handle. Arms may be of different lengths. Filaments may be of different lengths and/or different diameters.

### FIELD OF THE DISCLOSURE

The present disclosure relates to flossing instruments, and more particularly, to an instrument which supports more than one flossing filament.

### BACKGROUND

Flossing is an effective way of promoting dental health. Some people support a flossing filament in their fingers while flossing. For convenience, flossing instruments having a handle and a frame on which is supported a single flossing filament have been provided. However, tooth contours and tooth spacing vary, even within a single mouth. Gaps between teeth may vary such that no one thickness or diameter of flossing filament meets all needs. A flossing instrument may provide a compact way of holding a flossing filament taut deep within the mouth, where free or open space is minimal. However, the angle of the flossing filament to the handle of the flossing instrument may not be conducive to effective flossing. There exists room in the art for improved flossing instruments.

### SUMMARY

The disclosed concepts address the above stated situation by providing flossing instruments offering greater versatility than known types. To this end, there is disclosed a flossing instrument supporting more than one flossing filament. The flossing instrument may support two, three, or even more flossing filaments. The tool comprises a plurality of arms joined to one another. The arms may be joined at a common point, or alternatively, may join a common post. Each arm may support one or more ends of one or more flossing filaments. Flossing filaments may vary in length and in diameter from one another. The arms may have a dedicated handle, or alternatively, for compactness, may be without a handle.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a perspective view of a multi-filament flossing instrument, according to at least one aspect of the disclosure;

FIG. 1A is a plan view of a multi-filament flossing instrument, according to at least one aspect of the disclosure;

FIG. 2 is a perspective view of a multi-filament flossing instrument, according to at least one further aspect of the disclosure;

FIG. 2A is a plan view of a multi-filament flossing instrument, according to an additional aspect of the disclosure;

FIG. 3 is a perspective view of a multi-filament flossing instrument, according to still at least one additional aspect of the disclosure;

FIG. 4 is a perspective view of a multi-filament flossing instrument, according to another aspect of the disclosure; and

FIG. 5 is a perspective view of a multi-filament flossing instrument, according to still another aspect of the disclosure.

### DETAILED DESCRIPTION

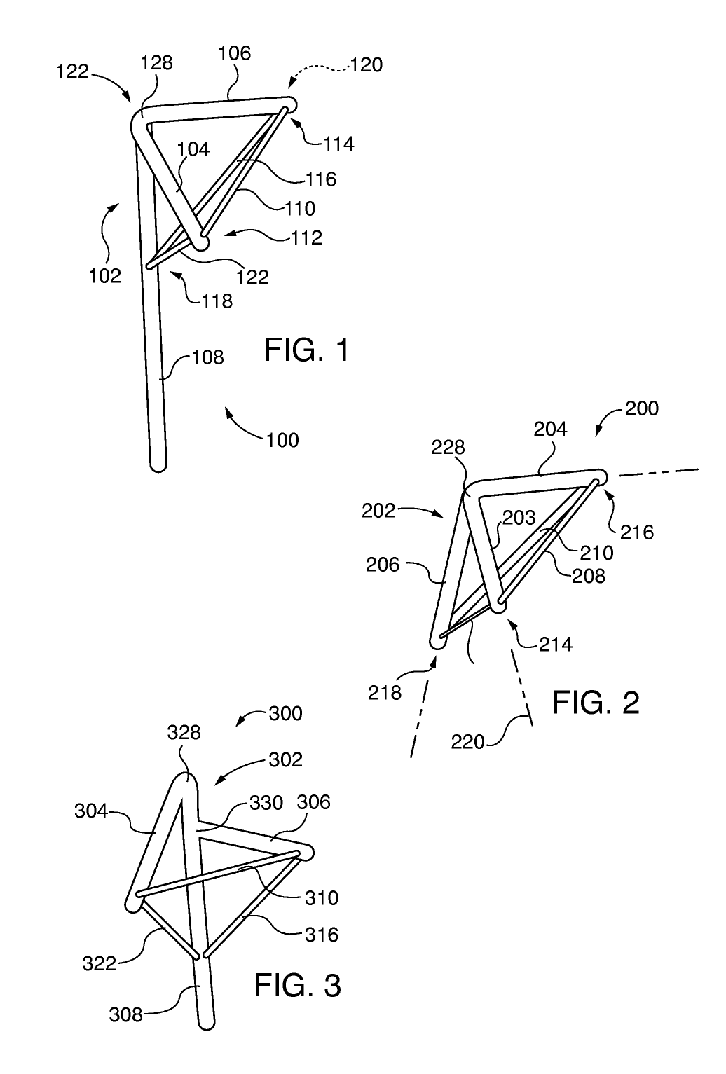

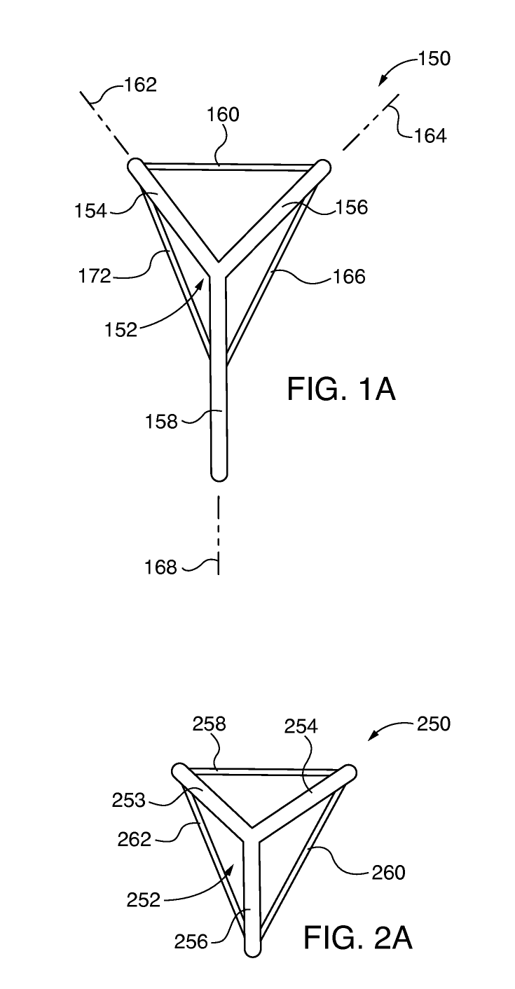

Referring first to FIG. 1, according to at least one aspect of the disclosure, there is shown a multi-filament flossing instrument 100, comprising a support frame 102 including a first arm 104, a second arm 106, and a third arm 108. A first filament 110 is fixed at one end 112 to first arm 104 and at an opposed end 114 to second arm 106. A second filament 116 is fixed at one end 118 to one of first, second, and third arms 104, 106, 108, and at an opposed end 120 to another one of first, second, and third arms 104, 106, 108. A third filament 122 is fixed at one end 124 to one of first, second, and third arms 104, 106, 108, and at an opposed end 126 to another one of first, second, and third arms 104, 106, 108. Support frame 102 will be understood to comprise arms 104, 106 and 108.

Provision of three filaments 110, 116, 122 gives the user a choice of filaments 110, 116, or 122. For any given surface portion of any given tooth being flossed, because filaments 110, 116 are differently oriented on support frame 102, one of filaments 110, 116, 122 may be more effective in reaching and scraping that surface portion. Filaments 110, 116, 122 may be embedded within first, second, and third arms 104, 106, 108, may be fusion bonded thereto, may be held by entrapment or interference, or may retained in any other suitable way.

Each filament 110, 116, or 122 is oriented so as to present at least a slightly different orientation to any one given tooth, compared to any other filament of any one multi-filament flossing instrument of the claims. This holds true for all implementations of all multi-filament flossing instruments disclosed herein.

Filaments 110, 116, 122 are of equal or identical diameters, and may be provided as three separate filaments, two separate filaments, or one continuous filament.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

Throughout this specification, and applying to all described and claimed implementations of the disclosure, because the disclosed multi-filament flossing instruments (e.g., multi-filament flossing instrument 100) are for flossing, filaments (e.g., filaments 110, 116) will be understood to comprise constituent material suitable for flossing. Also, because of the intended use as a flossing instrument, all multi-filament flossing instruments described or shown herein are dimensioned and configured to fit inside a human mouth. For example, In FIG. 1, in every one of the disclosed multi-filament flossing instruments described or shown herein, first and second arms 104, 106 are no greater in length than three quarters of an inch.

Furthermore, in all implementations of this disclosure, the term “support frame” (e.g., support frame 102 in FIG. 1) will refer to those arms shown and described for each implementation (e.g., arms 104, 106, 108 in FIG. 1).

In the example of FIG. 1, first, second, and third arms 104, 106, 108 join to one another at a common point 128 on support frame 102. Common point 128 is the intersection of first, second, and third arms 104, 106, 108.

At least two of first, second, and third arms 104, 106, 108 are of different lengths. As illustrated, third arm 108 is longer than first and second arms 104, 106. Arm 108 is sufficiently long to serve as a handle for finger grasp and manipulation of multi-filament flossing instrument 100.

FIG. 1A shows a multi-filament flossing instrument 150 which is generally similar to multi-filament flossing instrument 100, except that first, second, and third arms 154, 156, 158 of frame 152, and first, second, and third filaments 160, 166, 172 are all generally coplanar. That is, longitudinal centerlines 162, 164, 168 of first, second, and third arms 154, 156, 158 are coplanar.

Referring now to FIG. 2, a multi-filament flossing instrument 200 has first, second, and third arms 203, 204, 206 of equal length. First, second and third filaments 208, 210, 212 are each fixed at opposed ends to two of free ends 214, 216, 218 of first, second, and third arms 203, 204, 206. In the example of FIG. 2, first, second, and third arms 203, 204, 206 join to one another at a common point 228 on support frame 202. 10. In multi-filament flossing instrument 200, the first and second filaments 208, 210 are of equal length. However, in multi-filament flossing instrument 200, the first and second filaments 208, 210 are of different diameters. Third filament 212 may be of still another diameter if desired, or may be the same as one of first and second filaments 208, 210.

FIG. 2A shows a multi-filament flossing instrument 250 which corresponds to multi-filament flossing instrument 150, except that in the former, first, second, and third arms 253, 254, 256 are of equal length. First, second, and third arms 253, 254, 256 of frame 252 are coplanar, as are first, second, and third filaments 258, 260, 262.

Turning now to FIG. 3, a multi-filament flossing instrument 300 includes a frame 302 comprising first, second, and third arms 304, 306, and 308. First, second, and third filaments 310, 316, 322 are fixed to first, second, and third arms 304, 306, 308. The first and second arms 304, 306 join to the third arm 308 at points 328, 330 spaced apart from one another along the third arm 308.

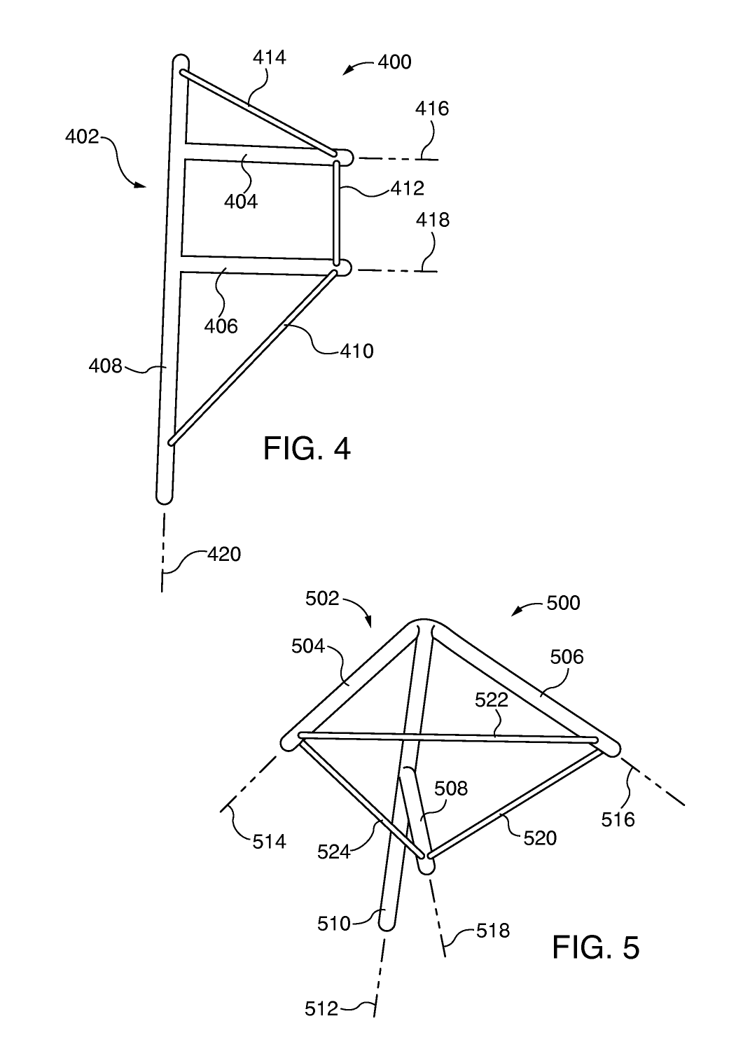

As seen in FIG. 4, a multi-filament flossing instrument 400 includes first, second, and third arms 404, 406, 408 joined together to form a frame 402. First, second, and third arms 404, 406, 408 support first, second, and third filaments 410, 412, 414 in a manner similar to that of multi-filament flossing instruments 100, 200, and 300 of FIGS. 1, 2, and 3. Longitudinal center lines 416, 418, 420 of respective first, second, and third arms 404, 406, 408 are coplanar. By contrast with multi-filament flossing instrument 400, center lines of the first, second, and third arms are distributed throughout three dimensions. For example, in FIG. 2, center lines 220, 222, and 224 of first, second, and third arms 203, 204, and 206 are distributed throughout, or occupy, three dimensions.

Turning now to FIG. 5, a multi-filament flossing instrument 500 comprises a frame 502 including a first arm 504, a second arm 506, and third arm 508, and a fourth arm 510. Center line 512 of the fourth arm 510 is not aligned with the center lines 514, 516, 518 of any of the first, second, and third arms 504, 506, 508. First, second, and third filaments 520, 522, 524 are fixed to first, second, and third arms 504, 506, 508. The first and second filaments 520, 522 are of different lengths.

Flossing filaments may be taut as illustrated, or alternatively, may be somewhat longer than the distance separating their respective attachment points to arms. The latter option allows for a flossing filament to partially wrap around a tooth when being used to floss teeth.

As shown herein, arms are straight. However, arms could take other configurations, such as curved and bent.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A multi-filament flossing instrument, comprising:
a support frame including a first arm, a second arm, and a third arm;
a first filament fixed at one end to the first arm and at an opposed end to the second arm;
a second filament fixed at one end to one of the first, second, and third arms, and at an opposed end to another one of the first, second, and third arms.

2. The multi-filament flossing instrument of claim 1, wherein the first, second, and third arms join to one another at a common point on the support frame.

3. The multi-filament flossing instrument of claim 2, further comprising a third filament joined at one end to the first arm and at an opposed arm to one of the second and third arms.

4. The multi-filament flossing instrument of claim 3, wherein the first, second, and third arms are of equal length.

5. The multi-filament flossing instrument of claim 3, wherein at least two of the first, second, and third arms are of different lengths.

6. The multi-filament flossing instrument of claim 1, wherein the first and second arms join to the third arm at points spaced apart from one another along the third arm.

7. The multi-filament flossing instrument of claim 6, wherein the center lines of the first, second, and third arms are coplanar.

8. The multi-filament flossing instrument of claim 6, wherein the center lines of the first, second, and third arms are distributed throughout three dimensions.

9. The multi-filament flossing instrument of claim 1, further comprising a fourth arm, wherein the center line of the fourth arm is not aligned with the center line of any of the first, second, and third arms.

10. The multi-filament flossing instrument of claim 1, wherein the first and second filaments are of equal length.

11. The multi-filament flossing instrument of claim 1, wherein the first and second filaments are of different lengths.

12. The multi-filament flossing instrument of claim 1, wherein the first and second filaments are of identical diameters.

13. The multi-filament flossing instrument of claim 1, wherein the first and second filaments are of different diameters.

14. The multi-filament flossing instrument of claim 1, further comprising a third filament fixed at one end to one of the first, second, and third arms, and at an opposed end to another one of the first, second, and third arms.
